(19) United States
(12) Patent Application Publication
(10) Pub. No.: US 2003/0144916 A1
(43) Pub. Date: Jul. 31, 2003

(54) Manufacturer website, method and system for managing vendor purchase orders

(76) Inventors: Barry R. Mumm, Minnetonka, MN (US); Mary E. Rolf, Minneapolis, MN (US)

Correspondence Address: John Veldhuis-Kroeze, WESTMAN CHAMPLIN & KELLY, International Center, Suite 1600, 900 South Second Avenue, Minneapolis, MN, 55402-3319, US

(21) Appl. No.: 10/061,869

(22) Filed: Jan. 31, 2002

(51) Int. Cl. G06F 17/60

(52) U.S. Cl. 705/26

(57) ABSTRACT

A computer implemented method of managing purchase orders to one or more vendors includes importing purchase order data from a purchase order management computer system to a server computer. From the purchase order data, the server computer determines new purchase order information. The server computer then automatically generates e-mail notification to the vendor of the existence of a new purchase order for the vendor. The e-mail instructs the vendor to access a purchase order website in order to confirm receipt of the new purchase order. Additional e-mail reminders can be automatically generated if the vendor does not confirm receipt of the purchase order. Further e-mails can be automatically generated to remind the vendor to ship by an agreed upon date, to remind the vendor to provide shipping information by accessing the website, or for other purposes. Automatic exception reports, such as e-mails to a purchasing agent, can be generated if the quantities and delivery dates confirmed by the vendor differ from those requested.

### BACKGROUND OF THE INVENTION

The present invention relates to management of purchase orders between a manufacturer or purchaser and its vendors. More particularly, the present invention relates to an automated system and method which can be used by manufacturers or other purchasers to process, manage and monitor purchase orders to vendors.

In manufacturing, and other fields, significant time and effort is required of the manufacturer's purchasing agents in order to guarantee that the manufacturer has on hand the materials needed to fill orders from customers in a timely fashion. This is particularly true in manufacturing environments where “just in time” inventory delivery is preferred. Although automated systems exist for notifying the manufacturer's purchasing agents when inventory of particular components needs to be re-supplied, a large portion of the purchasing agent's time and effort is spent after a purchase order to a particular vendor is placed.

Typically, the purchasing agent must verify that the vendor received the purchase order, confirm that the vendor has agreed to supply the quantities specified by the manufacturer and within the time frame requested, and otherwise coordinate the details of the purchase. If the vendor does not commit to the terms of the purchase order, but instead proposes alternate terms (i.e., quantities, delivery dates, etc.) the tasks of the purchasing agent become even more complex. It can be exceedingly difficult to manage a large number of purchase orders in situations where vendors agree to only some of the terms of the purchase orders.

Once a purchase order has been accepted by a vendor, the manufacturer's purchasing agent typically must follow-up with the vendor, on a frequent basis, to ensure that the vendor will actually meet the promised delivery dates, quantities, etc. Thus, the task of managing a large number of purchase orders would be difficult even for a “perfect” purchasing agent. Because of the significant effort associated with each purchase order, a manufacturer typically must employ a high number of purchasing agents in order to supervise large quantities of purchase orders. This results in increased overhead for the manufacturer, and introduces the potential for human error in the process since most purchasing agents are not “perfect” in their ability to manage this complex situation.

Systems are known in the art which automate certain aspects of the purchase order process. For example, from the manufacturer's (or other buyer's) perspective, there are vendor systems which automatically generate an e-mail or EDI (electronic data interchange) to the manufacturer with information such as confirmation codes, quantities ordered, projected shipment dates, etc. Similarly, from the manufacturer's perspective, there are systems which automatically generate purchase orders. Some of these systems even automatically e-mail these purchase orders to vendors. However, even with automatic generation of purchase orders, once the purchase orders are transmitted to the vendors, purchasing agents must still check on the status of the purchase orders, provide reminders to the vendors, and otherwise manage the process.

Further, many of these existing purchase order automation systems require that the vendors use proprietary software specific to the particular manufacturer. For vendors that provide components to a large number or manufacturers, this is often an overly burdensome requirement. Also, in order to allow the vendor to “dial into” the manufacturer's proprietary system, maintaining the integrity of the manufacturer's systems and databases can become more difficult.

Consequently, a method and system for managing vendor purchase orders placed by a manufacturer, which overcomes some or all of the above-described problems, would be a significant improvement in the art.

### SUMMARY OF THE INVENTION

A computer implemented method of managing purchase orders to one or more vendors includes importing purchase order data from a purchase order management computer system to a server computer. From the purchase order data, the server computer determines new purchase order information. The server computer then automatically generates e-mail notification to the vendor of the existence of a new purchase order for the vendor. The e-mail instructs the vendor to access a purchase order website in order to confirm receipt of the new purchase order. Additional e-mail reminders can be automatically generated if the vendor does not confirm receipt of the purchase order. Further e-mails can be automatically generated to remind the vendor to ship by an agreed upon date, to remind the vendor to provide shipping information by accessing the website, or for other purposes. Automatic exception reports, such as e-mails to a purchasing agent, can be generated if the quantities and delivery dates confirmed by the vendor differ from those requested.

### BRIEF DESCRIPTION OF THE DRAWINGS

FIG. 1 is a block diagram illustrating a web-based system for managing vendor purchase orders in accordance with embodiments of the present invention.

FIG. 2 is a flow diagram illustrating an automated e-mail program and method in accordance with certain aspects and embodiments of the present invention.

FIGS. 3-5 and 6B are examples of reminder e-mails generated by the automated e-mail program illustrated in FIG. 2, with the manufacturer being shown as Rosemount Office Systems Inc. for illustrative purposes.

FIG. 6A is a flow diagram illustrating a further portion of a method in accordance with the invention.

FIG. 6C is an example of an exception report which can be generated and/or e-mailed to desired individuals to notify them of a purchase order discrepancy.

FIG. 7 is a block diagram of an exemplary computer environment such as can be used as a vendor computer operated by a vendor and used to access the system illustrated in FIG. 1.

FIGS. 8-10 are pictorial representations of a display or monitor of the vendor computer shown in FIGS. 1 and 7, illustrating web page features of the system in accordance with an example embodiment of the invention in which the manufacturer is shown to be Rosemount Office Systems Inc.

### DETAILED DESCRIPTION OF ILLUSTRATIVE EMBODIMENTS

The present invention provides a unique solution to the above-described problems faced by manufacturers, wholesalers, or other purchasers (all generically referred to herein as “manufacturers”). The invention includes a software system which simulates the actions of a “perfect” purchasing agent. In the software system of the present invention, which is a manufacturer or purchaser based system as opposed to a vendor based system, all communication between the system and the vendor can take place via e-mail and the worldwide web (WWW). For example, the system automatically notifies via e-mail vendors of the existence of an electronic purchase order generated by the manufacturer, tracks vendor confirmation and acceptance of the purchase order and conditions therein, generates reminders to the vendor of upcoming promised shipment dates, and reminds the vendor to confirm the shipping details upon shipping the order. In order to adapt to a particular vendor situation, some or all vendor actions trigger additional logic which notifies the purchasing agents of necessary information such as variances to quantities and delivery dates. These and other features of the present invention are described below with reference to the FIGS.

The invention therefore includes a method of generating, confirming and/or managing purchase orders between a manufacturer (to include other types of purchasers) and one or more vendors. The invention also includes computer systems such as web server and vendor based computer systems, which embody the disclosed method. Further, the present invention includes other embodiments such as computer readable medium containing executable instructions which implement the methods of the invention.

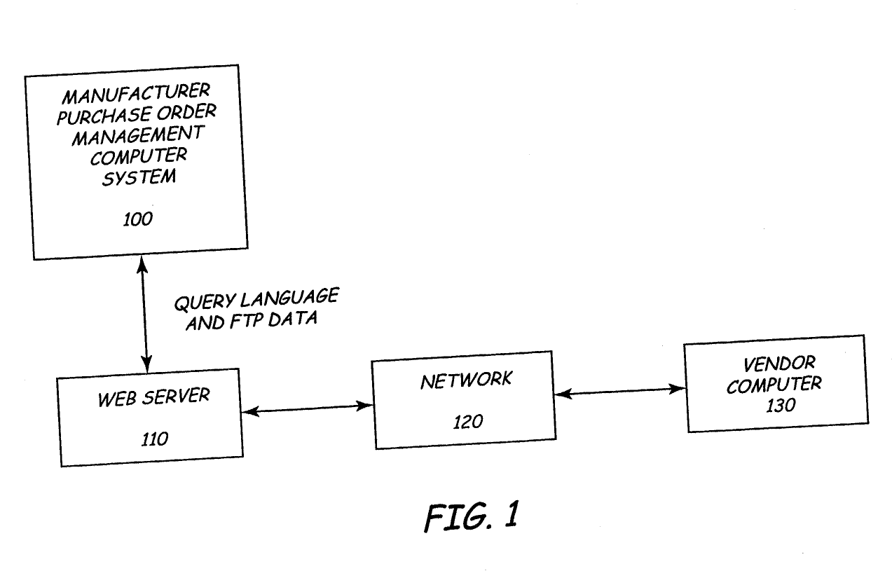

FIG. 1 is a block diagram of a computer system in accordance with embodiments of the invention. The computer system can be a web-based computer system which utilizes the internet as a computer network for communication, or it can be a computer system which utilizes other computer networks for communication. In either case, the computer system utilizes or is accessed by a web browser or other similar non-proprietary software operating on a vendor computer at a vendor location to access manufacturer purchase order information. The phrase “non-proprietary software” is intended to reference software products, such as Internet web browsers, which are in common use by the general public. The phrase is not intended to represent that the software can be freely copied without compliance with the terms of any license agreements with the owner of the software.

In one embodiment, the computer system illustrated in FIG. 1 includes a web server 110 which hosts a web page for a manufacturer. The web server 110 utilizes a computer network 120, for example the internet, to transmit computer executable instructions to a vendor computer 130 operated by a vendor. Web server 110 also receives, over network 120, data input into vendor computer 130 by the vendor.

Web server 110 is coupled in communication with the manufacturer's purchase order management computer system 100. Computer system 100 can be, for example, a mainframe computer which stores and possibly internally manages database information such as current inventory, future inventory needs, purchase orders, etc. Typically, computer system 100 is a proprietary system, with the databases containing information which must be kept confidential or closely controlled in order to protect the manufacturer. Therefore, it is often undesirable to allow vendors direct access to computer system 100.

At regularly scheduled intervals, a query language is executed within computer system 100 in order to extract and export purchase order data for transmission to web server 110. The data is sent to web server 110 using a file transfer protocol (FTP) In some embodiments, the query language is executed and the data is exported once per day, for example in the middle of the night when other uses of computer system 100 are at a minimum. However, in other embodiments the query language is executed at more frequent intervals.

In one example embodiment for a specific manufacturer data base, the data export from computer system 100 sends the following database files via FTP to web server 110: PHDTL.mdb, POCMT.mdb, POHDR.mdb and POQTCMT.mdb. The contents of these databases can be seen in Tables 1-4.

The purchase order header database file, POHDR.mdb, contains the fields illustrated in Table 1:

TABLE 1

| Field Name | Description |
|---|---|
| WHPO | PO Number |
| WHDADD | Date Entered |
| WHCADD | Century Date |
| WHDREV | Revision Date |
| WHDCREV | Revision Century |
| WHREV | Revision Number |
| WHPT | Contact name |
| WHSNAME | Ship to name |
| WHSAD1 | Ship to Address 1 |
| WHSAD2 | Ship to Address 2 |
| WHSAD3 | Ship to Address 3 |
| WHSCTY | Ship to city |
| WHSST | Ship to state |
| WHSZIP | Ship to zip |
| WHVMKY | Vendor Number |
| WHSP | Drop ship number |
| WHRNAM | Vendor name |
| WHRAD1 | Vendor address 1 |
| WHRAD2 | Vendor address 2 |
| WHRAD3 | Vendor address 3 |
| WHRCTY | Vendor city |
| WHRST | Vendor state |
| WHRZIP | Vendor zip |
| WHVALU | PO value |
| WHBUY | Buyer Number |
| WHNAME | Buyer Name |
| WHTMC | Payment terms |
| WHTAX | Taxable y/n |
| WHSV | Ship via |
| WHFOB | Freight handling |
| WHPDATE | ? |
| WHDTE | Date stamp |
| WHTIME | Time stamp |

The purchase order line item detail database file, PHDTL.mdb, contains the fields illustrated in Table 2:

TABLE 2

| Field Name | Description |
|---|---|
| WDPO | PO number |
| WDLIN# | Line number |
| WDPN | Part number |
| WDDWRL | Drawing revision letter |
| WDUM | Purchase unit of measurement |
| WDOQT | Order quantity |
| WDRQD | Required date |
| WDRDM | Required date |
| WDRDY | Required date-century |
| WDPPPM | Price per |
| WDACCT | GL account |
| WDDESC | Description |
| WDTMC | Contact number |
| WDDLVT | Deliver to |
| WDPPP | Line price |
| WDUPRC | Unit price |
| WDDTE | Date stamp |
| WDTIME | Time stamp |
| WDVNR# | Vendor Part Number |

The purchase order line comment database file, POCMT.mdb, contains the fields illustrated in Table 3:

TABLE 3

| Field Name | Description |
|---|---|
| WCPO | PO number |
| WCLIN# | Positioner |
| WCP1 | Comment |
| WCDTE | Date stamp |
| WCTIME | Time stamp |

Purchase order quote comment database, POQTCMT.mdb, contains the fields illustrated in Table 4:

TABLE 4

| Field Name | Description |
|---|---|
| WVPO | PO number |
| WVVMKY | Vendor Number |
| WVCPN | Mfr. Part Number |
| WVLIN# | PO Line Number |
| WVCMT | Comment |
| WVDTE | Date stamp |
| WVTIME | Time stamp |

Again, the database files shown in Tables 1-4 are provided as examples of the type of data which can be sent, via a FTP or by other means, from computer system 100 to web server 110 at regularly scheduled times. The particular examples shown in Tables 1-4 are not limiting to the concepts of the invention, as one of skill in the art will recognize that more, less or different data can be transferred to practice the invention as described herein.

In some embodiments, web server 110 represents multiple different servers working in conjunction. For example, the database files shown in Tables 1-4 can be sent via FTP to an FTP server. The database files can then be reformatted and transferred to a second server if desired. In the present application, web server 110 should be construed as including multiple server embodiments as well as single server embodiments.

In the example embodiment discussed above, once received by server 110, the data in files PHDTL.mdb, POCMT.mdb, POHDR.mdb and POQTCMT.mdb are imported into a master applications database (also running on server 110). The data in these four databases are imported into the same named fields in the master application database. An exception in this particular example includes the two fields named LIN#. These are renamed to LINNUM because the “#” character is reserved in access sql for delimiting date data.

POHDR.mdb→WEB_POHDR

PHDTL.mdb→WEB_PODTL

POCMT.mdb→WEB_POCMT

POQTCMT.mdb→WEB_POQTCMT

The other tables in the master database are as follows:

Users are defined in this example as shown in Table 5.

TABLE 5

| Field Name | Description |
|---|---|
| ID | Unique record identifier; auto |
| | assigned by database |
| User_ID | Manufacturer assigned logon id |
| User_Pass | Manufacturer assigned logon password |
| User_Level | Access level: supplier, national |
| | (for buyers), or admin |
| User_Name | User's name |
| Vendor_Co_Name | User's company name |
| User_Email | E-mail address of user |

The database illustrated in Table 6, PO_ACK, is indicative of the date when the purchase order receipt confirmation is received.

TABLE 6

| Field Name | Description |
|---|---|
| ID | Auto assigned unique record id number |
| WDPO | Foreign key for PO Number |
| PO_ACK_DATE | Date of receipt of confirmation |
| QS_CONFIRM_DATE | Date of confirmation of promised |
| | quantities and delivery dates |

The database shown in Table 7, PODTL_SHIP_INFO, keeps track of promised quantities and delivery dates, plus carrier and PRO numbers for each line item in a purchase order.

TABLE 7

| Field Name | Description |
|---|---|
| ID | Auto assigned unique record id number |
| WDPO | Foreign key for PO number |
| WDLINNUM | Foreign key for line number |
| SHIP_QTY | Promised quantity |
| PRM_DATE | Promised delivery date |
| CARRIER | Carrier name |
| PRONUM | Carrier PRO number |
| LAST_UPDATE | Date of last update to record |

After the data is imported into the master applications database at server 110 (or an associated system accessible by server 110), sub-routines or programs are run on server 110 to identify new purchase order information or other information which triggers an automated e-mail program to perform manufacturer-vendor communication tasks which would normally be performed by human purchasing agents.

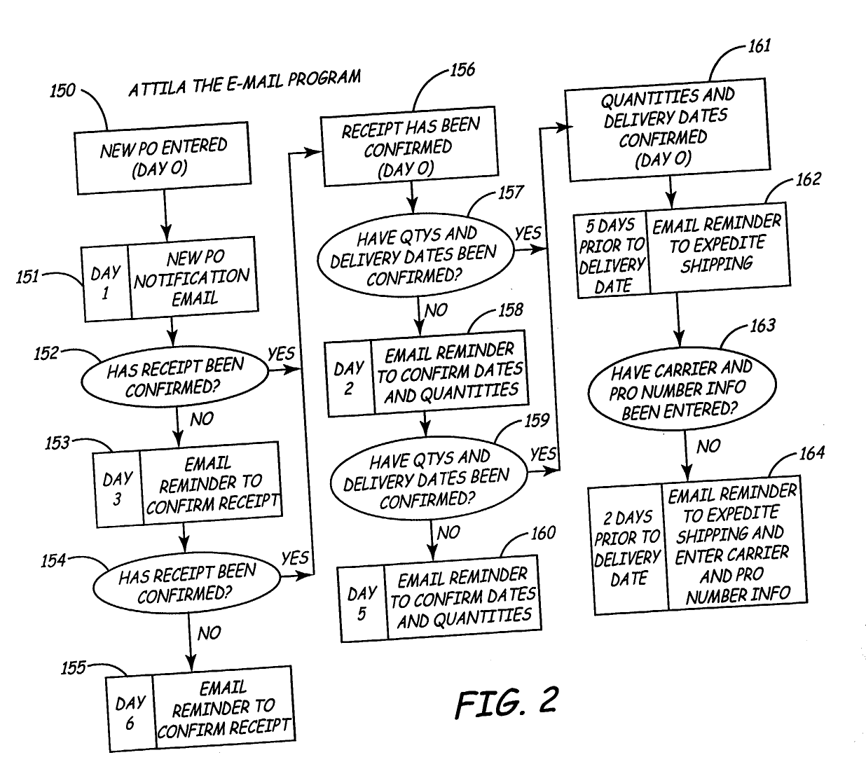

FIG. 2 is a block diagram illustrating an e-mail program run on server 110 based upon the data which has been imported into the master applications data base. After the data is imported, the application looks for exceptions, non-confirmations, purchase orders with no quantities or dates confirmed, and promised dates within a specified number of days. If certain conditions are not met, or at predetermined times, e-mails are automatically generated and sent to the vendor as a reminder of a particular condition. Also, a copy of the e-mails can be sent to a purchasing agent or other employees of the manufacturer in order to notify them that a purchase order fits into any of a number of non-conformities outlined by the manufacturer.

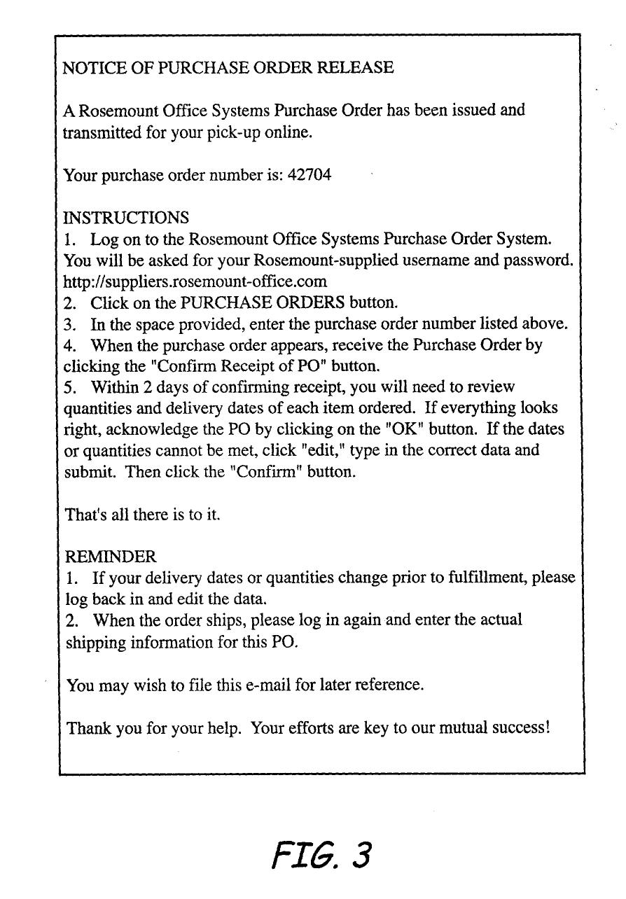

The particular date or other requirements specified in the flow diagram of FIG. 2 are provided as example, and are not intended to limit the invention. As shown in step 150 in FIG. 2, new purchase order data is entered or imported into the applications data base (at day 0 for example). At step 151, a new purchase order notification e-mail is generated and transmitted (at day 1 in this example) to the particular vendor specified in the purchase order. FIG. 3 is an illustration of one possible purchase order notification e-mail which can be sent to a vendor. Although the purchase order notification e-mail shown in FIG. 3 is tailored specifically for Rosemount Office Systems, one skilled in the art will recognize that this e-mail notification can be revised to fit the needs of other particular manufacturers.

The purchase order notification e-mail shown in FIG. 3 notifies the vendor that a purchase order has been issued and is ready for on-line pick up using a web browser. To that end, the e-mail notifies the vendor of a purchase order number and provides instructions to the vendor on how to access the purchase order. The e-mail also instructs the vendor how to confirm receipt of the purchase order, as well as how to accept or revise the quantities and delivery dates specified in the purchase order.

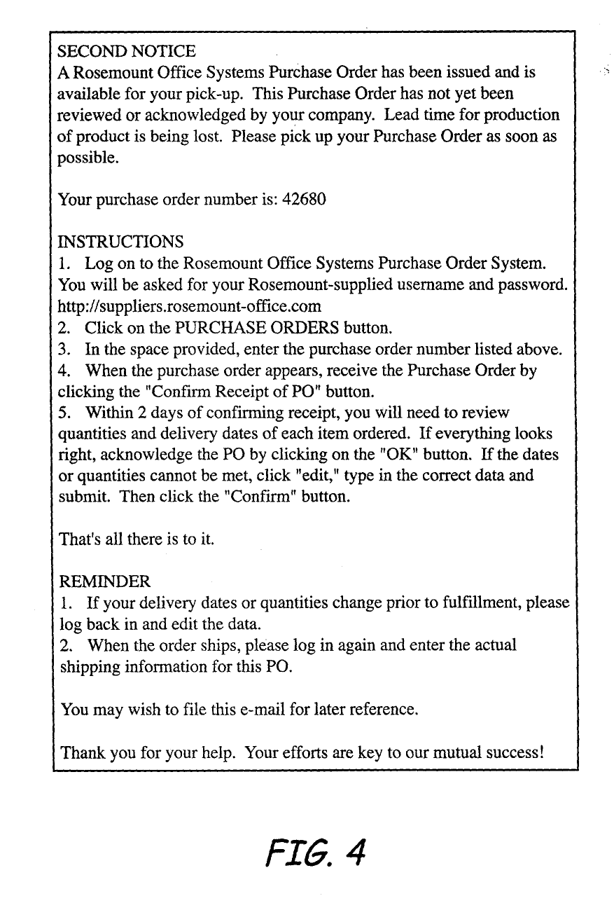

At step 152, a determination is made as to whether receipt of the purchase order has been confirmed by the vendor. In other words, a determination is made as to whether the vendor has logged onto the website on server 110 and responded as instructed in the notification e-mail sent in step 151. If it is determined that receipt of the purchase order has not been confirmed, in step 153 an e-mail reminder is sent (during day 3 in this particular example) to confirm receipt of the purchase order. An example or a reminder e-mail is provided in FIG. 4. As shown in step 154, subsequent determinations as to whether receipt of the purchase order has been confirmed can be made, with subsequent e-mail reminders provided to the vendor.

If at either of steps 152 or 154 it is determined that the vendor has confirmed receipt of the purchase order, this decision is logged at step 156 and a new time line begins (note in this example that a date is again set to day 0). At step 157 a determination is made as to whether the quantities and delivery dates specified in the purchase order have been confirmed by the vendor. If it is determined that the quantities and delivery dates have not been confirmed by the vendor, at a predetermined time (i.e. day 2 in this example) an e-mail reminder to confirm dates and quantities is generated and transmitted to the vendor. This is illustrated at step 158. Then, at a later date, the determination is again made as to whether the quantities and delivery dates specified in the purchase order have been confirmed by the vendor, and if they have not been confirmed by the vendor, then subsequent e-mail reminders to confirm the dates and quantities are transmitted to the vendor. These steps are illustrated, for example, in blocks 159 and 160 in FIG. 2.

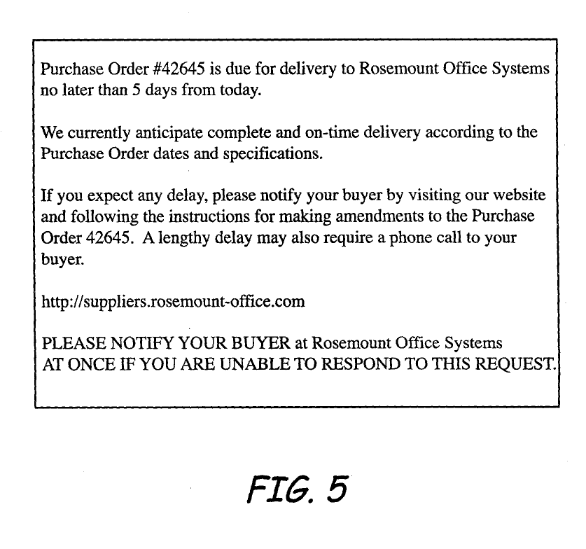

Once a determination is made that the quantities and delivery dates have been confirmed, at step 161 the time line can again be reset. A pre-determined number of days prior to the delivery dates agreed upon by the vendor, an e-mail reminder to expedite shipping is generated and transmitted to the vendor as shown at step 162. An example of an e-mail reminder to expedite shipping is provided in FIG. 5. In the e-mail which reminds the vendor to expedite shipping, the vendor can be instructed to notify the manufacturer's purchasing agent by visiting the website and following the instructions for making amendments to the purchase order.

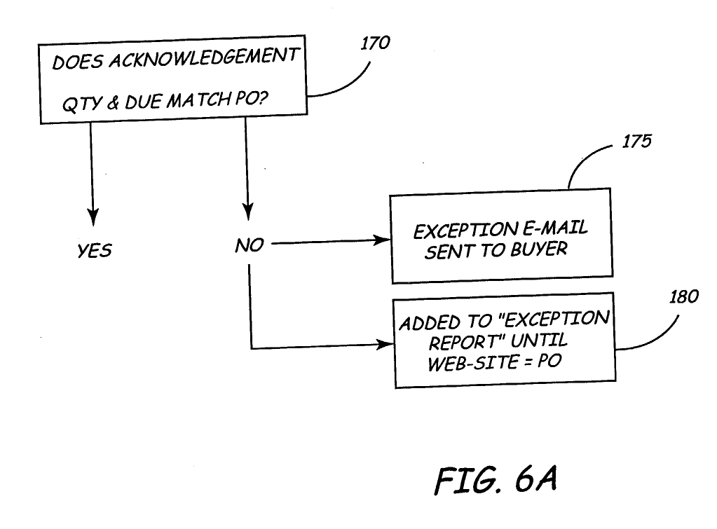

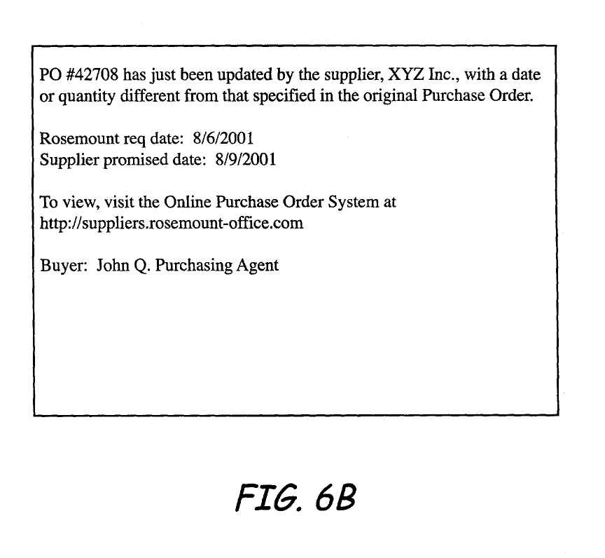

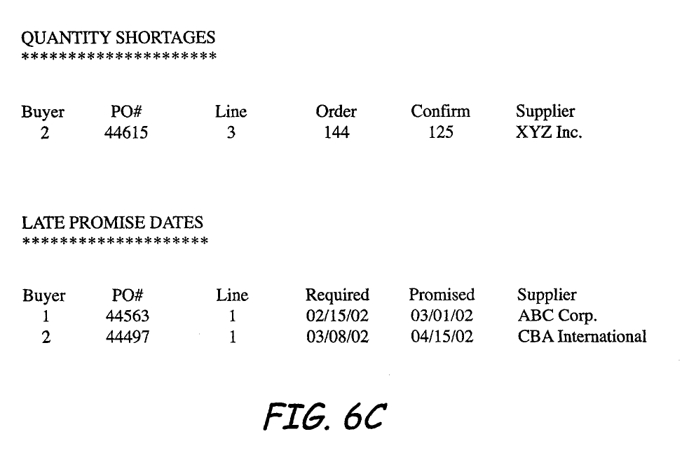

Any amendments to the purchase order trigger additional logic at web server 110, which results in the generation of e-mails or other messages to notify the purchasing agent of the purchase order non-conformity. This allows the purchasing agent to respond accordingly to the vendor and/or to customer's of the manufacturer. As shown in FIG. 6A, when the vendor acknowledges the purchase order using the web-site, or at any time that the vendor revises the quantity or due dates of a particular purchase order using the web-site, a determination is made at step 170 as to whether the acknowledged quantity and due date match the purchase order details. If they do, the process proceeds as described. If they do not match, then at steps 175 and 180 an exception e-mail is sent to the purchasing agent or buyer and the discrepancy is added to an exception report. An example of an e-mail notification to the purchasing agent is provided in FIG. 6B. An example of an exception report is provided in FIG. 6C.

At step 163, a determination is made as whether the vendor has notified the manufacturer of the shipping carrier and PRO number information by entering this data while visiting the manufacturer's website. By way of example only, PRO numbers can be utilized to identify a specific shipment to a customer, generally made via common carrier (also described as Less Than Truckload (LTL) size shipment), but occasionally a truckload hauler will also utilize a PRO number. A PRO number is an alphanumeric descriptor from 7 to 12 characters long, which is unique to the freight hauler and to the specific shipment, and is assigned by the manufacturer at the time of shipment. The PRO number usually identifies the freight hauler's originating terminal, but does not in itself identify the consignee or destination. If the carrier and PRO number information has not been entered a predetermined number of days prior to the delivery date, another e-mail reminder to expedite shipping and enter the carrier and PRO number information can be generated and transmitted as shown at step 164.

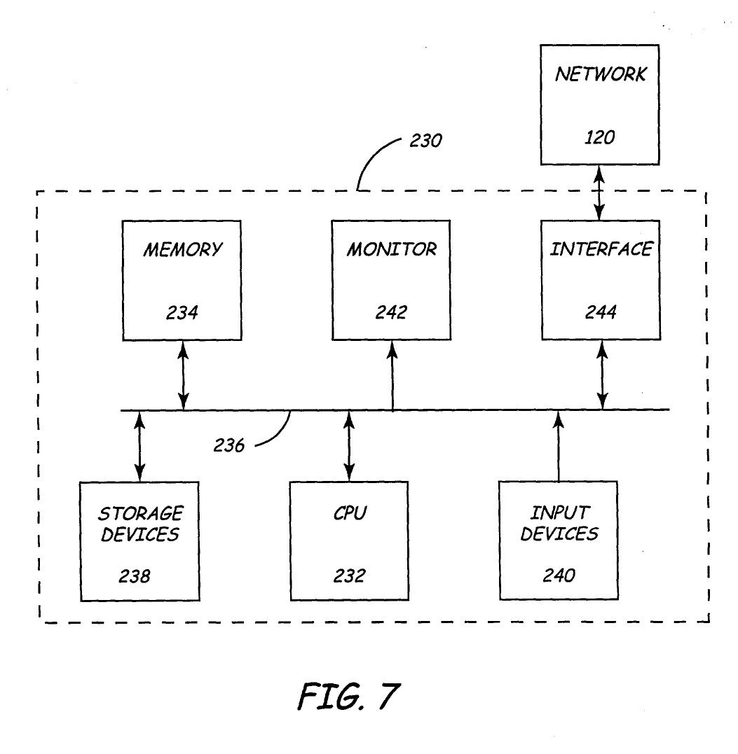

FIG. 7 and the related discussion provide a brief, general description of a computing environment 230 in which the invention may be implemented. The computing environment 230 illustrated in FIG. 7 is exemplary of a computing environment such as vendor computer 130, but can generally represent a web server environment as well. It must be noted that aspects of the invention are implemented within web server 110, but not necessarily in vendor computer 130.

Although not required, the present invention will be described, at least in part, in the general context of computer-executable instructions, such as program modules, being executed by a computing environment (such as vendor computer 130 or a web server computer 110). Generally, program modules include routines programs, objects, components, data structures, etc., which perform particular tasks or implement particular abstract data types. Tasks performed by the program modules are described below with the aid of block diagrams and flow charts. Those skilled in the art can implement the description, block diagrams and flow charts to computer executable instructions. In addition, those skilled in the art will appreciate that the invention may be practiced with other computer system configurations, including multi-processor systems, networked personal computers, mini-computers, mainframe computers, and the like. The invention may also be practiced in distributed computing environments where tasks are performed by remote processing devices that are linked through a communication network. In a distributed environment, program modules and/or data may be located in both local and remote memory storage devices

The computer 230 illustrated in FIG. 7 comprises a conventional computer having a central processing unit (CPU) 232, memory 234 and a system bus 236, which couples various system components, including the memory 234 to the CPU 232. The system bus 236 may be any of several types of bus structures, including a memory bus or a memory controller, a peripheral bus, a network bus and a local bus using any of a variety of bus architectures. The memory 234 includes read-only memory (ROM) and random access memory (RAM). A basic input/output (BIOS) containing the basic routine that helps to transfer information between elements within the computer 230, such as during start-up, is stored in ROM. Storage devices 238, such as a hard disc, a floppy disk drive, an optical disk drive, etc., are coupled to the system bus 236 and are used for storage of program modules and data. It should be appreciated by those skilled in the art that other types of computer readable media that are accessible by a computer, such as magnetic cassettes, flash memory cards, CD-ROM, digital video disks, random access memories, ROMs, and the like may also be used as storage devices. Commonly, programs are loaded into memory 234 from at least one of the storage devices 238 with or without accompanying data. An input device 240, such as a keyboard, pointing device (i.e. mouse, etc.), or the like, allows an operator to provide commands to the computer 230. A monitor or display 242, or other type of output device, is further connected to the system bus 236 via a suitable interface, and provides feedback to the operator. Computer 230 can communicate with other computers, or a network of computers such as the Internet, through a wired or wireless communications link and an interface 244, such as a modem, network card, or the like. In one embodiment, computer 230 can organize, present and solicit information to and from a customer through a website. As discussed above, computing environment 230 can be identified as a server, while remote computers are identified as clients. As discussed above, computer 230 is also generally descriptive of a computing environment which can be used as a vendor computer 130 (FIG. 1). Remote customers on the vendor computer can access the website using the vendor computer and a browser, such as MICROSOFT INTERNET EXPLORER or NETSCAPE NAVIGATOR.

In some embodiments of the present invention, the computer executable instructions contained on a computer readable medium or transmitted in a carrier wave signal include mark-up languages such as HTML, XHTML, CHTML, XML, WML or other mark-up languages frequently used in web page development. However, the present invention is not limited in any respect to embodiments in which the computer executable instructions are embodied as mark-up languages.

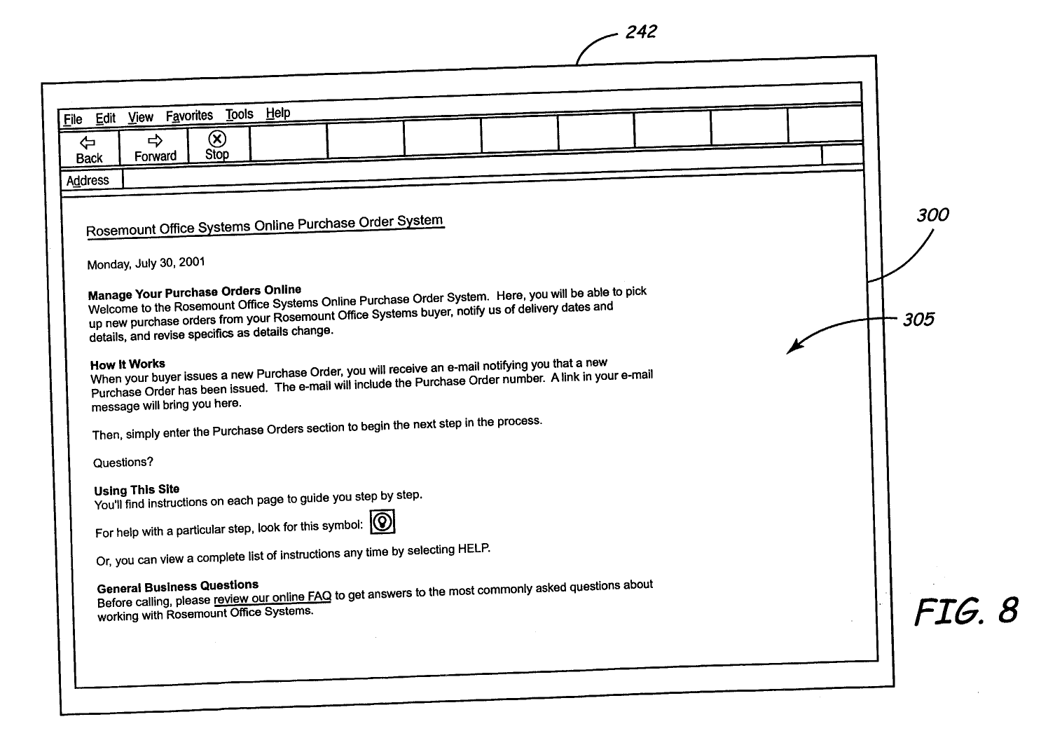

FIGS. 8-10 are pictorial illustrations of web pages which can be displayed on a monitor 242 of a vendor computer 130 using a web browser 300. In a conventional manner, input devices 240 (shown in FIG. 7) such as a keyboard and/or pointing device are used to provide inputs to the vendor computer in order to effect changes in the web page displayed by web browser 300 and/or to provide information to web server 110 via computer network 120. Although only three separate web pages are illustrated in FIGS. 8-10, other web pages can be added to the system of the present invention without departing from the spirit and scope of the invention.

Using a web browser 300, a vendor can access the manufacturer website hosted on server 110 in order to confirm, or suggest modification to, the purchase order. In order to access the site, a successful login must be completed. Login username and password are entered and compared to the database Users table. If there is a match, the vendor's computer receives a cookie. This cookie will time out after the user stops using the site for an hour, or if they hit the logout button.

In one embodiment, every page hit a user makes after successfully logging in calls an include file called securityrequired.asp. The script in this file checks the users cookie to see if they are indeed logged in. If it finds the login cookie, it pulls the user's name and security level from the cookie, then resets the timeout for an hour. If the script does not find the login cookie, it automatically redirects the user to a login page to request another login.

In one embodiment, there are three security levels in the Vendor purchase order application running on web server 110:

The “admin” security level has access to all parts of the web application. With this level of security access, a user is able to view all purchase orders, edit information within the purchase orders, and access the administration portion of the site.

The “national” level is for purchasing agents of the manufacturer. With the security level, they have access to view all purchase orders and can access the exception reports. They do not have access to edit purchase order information, nor do they have access to the user administration portion of the site.

The “supplier” level is for individual vendors or suppliers to view and print their own purchase orders, as well as to edit the information in the purchase orders. They have access only to their own purchase orders, and cannot see any other vendor's purchase orders.

The security level information is kept in the cookie and is accessed each time the user requests a new page on the website. The information presented to the user via the web page is then based on their User ID and their security level by if/then logic statements within the scripting of each page.

In some embodiments of the invention, when the vendor first accesses the website, computer executable instructions are transmitted over the network 120 in order to prompt the user to enter a username and password which are specifically assigned to only that vendor. After login, the user is taken to a manufacturer homepage 305 shown in FIG. 8. This is a jump page to the rest of the site and contains up-to-date news items. If the user is admin level, there will be a link at the bottom of this page to access the user administration. This is the only place where there is a link to user administration.

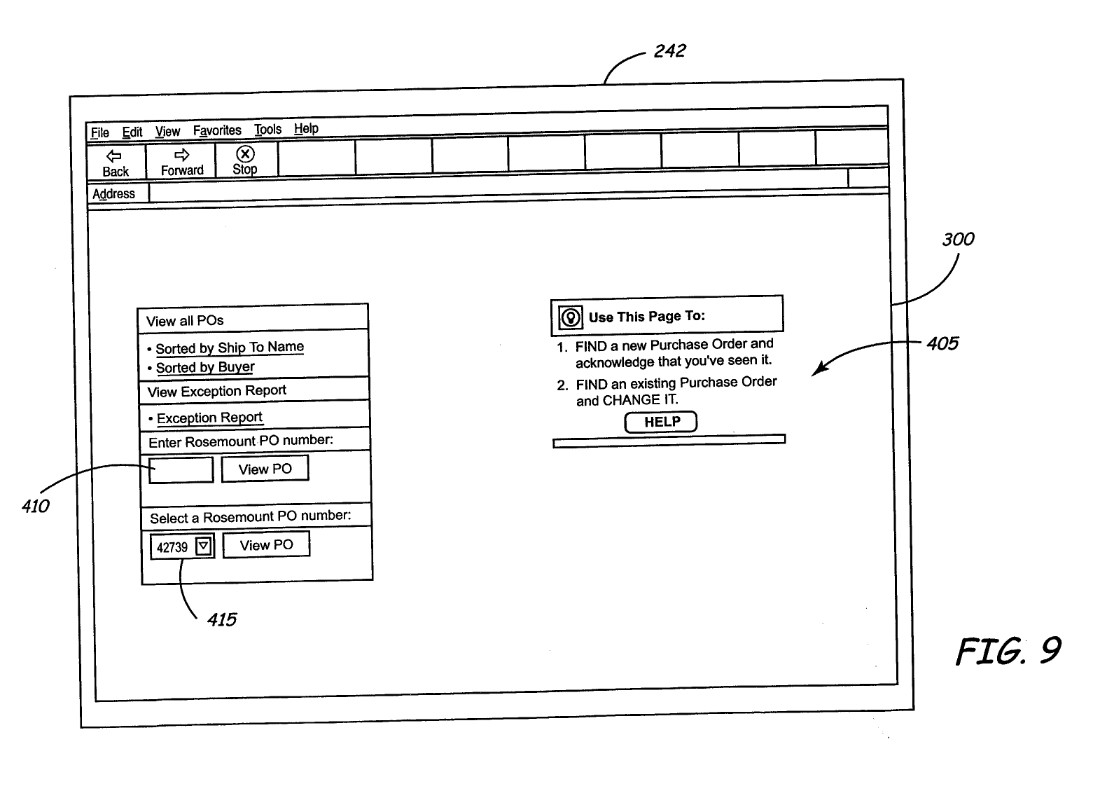

After logging in, the vendor has access to another web page 405 shown in FIG. 9 which can be used to search for particular purchase orders. By filling in a purchase order number in input 410, or selecting a purchase order number from a drop down list of purchase orders for that particular vendor in input 415, the vendor can access a specific purchase order for purposes of accepting, rejecting or suggesting modifications.

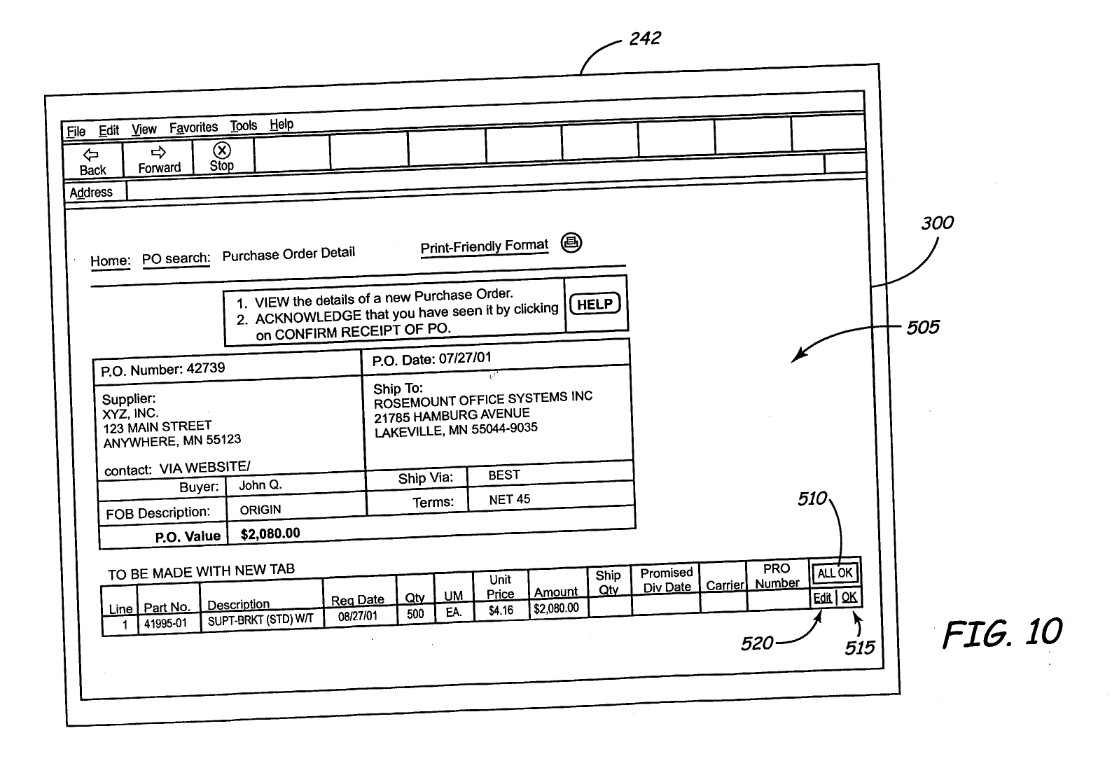

Once a particular purchase order has been selected by the vendor, a web page 505 shown in FIG. 10 can be accessed. Depending on what stage of the purchase order they are at, different information and instructions will be displayed to the vendor. The first step for vendors or suppliers is to acknowledge that they have received the purchase order and that they will work to fulfill the order. Once a vendor or supplier has received the purchase order, they will need to specify promised quantities and delivery dates. This can be accomplished as follows:

a. Clicking the “All OK” button 510. This is done if the supplier agrees that all quantities and dates are OK. Doing this automatically fills in the agreed upon quantities and dates for all line items with the same values as the requested quantities and dates.

b. Clicking the “OK” or “Edit” links 515 or 520 on any of the line items. OK link 510 will auto fill in the quantity and date for that line item only. Edit link 520 will pop up a window that the suppliers can use to fill in their own quantity and date specifications.

c. Once all promised quantities and dates have been filled in for all line items, the supplier needs to click the “Confirm” button (not specifically shown in FIG. 10). This will check behind the scenes for any exceptions. If there are exceptions, it will send an e-mail immediately to the purchasing agent and, if desired, to management personal of the manufacturer. If the vendor neglects to click the button, the quantities and dates are still logged in the database, and the nightly process will catch any exceptions and include them in the exception report e-mail.

When an order has been completed and shipped, the vendor or supplier should come back to the website and open up the purchase order detail page 505 a final time to enter the Carrier and PRO number information so the manufacturer can track the shipment.

The present invention allows a purchasing agent of a manufacturer to efficiently manage a large number of purchase orders by automating the purchase order generation and acceptance processes. Further, by generating reminders to the vendors, as well as exception reports to the purchasing agent, the workload of the purchasing agent is greatly reduced for each purchase order.

Although the present invention has been described with reference to preferred embodiments, workers skilled in the art will recognize that changes may be made in form and detail without departing from the spirit and scope of the invention. For example, while in some embodiments the term “e-mail” is intended to be an electronic message transmitted over the internet, in other embodiments the electronic notification can be over other wire or wireless networks and the term “e-mail” is intended to cover these wire and wireless transmissions. Further, the term e-mail can, in some embodiments, include the electronic generation of a notification or reminder which is then transmitted to a facsimile machine of the vendor or purchasing agent, for example. Other electronic notifications which constitute “e-mails” include, but are not limited to, automated voice messaging, alphanumeric test based paging, EDI, and the like.

What is claimed is:

1. A computer implemented method of managing purchase orders to one or more vendors, the method comprising:
importing purchase order data from a purchase order management computer system to a server computer;
determining new purchase order information from the purchase order data; and
generating from the server computer an e-mail notification to a vendor of the existence of a new purchase order for the vendor and instructing the vendor to access a purchase order website in order to confirm receipt of the new purchase order.

2. The computer implemented method of claim 1, wherein determining the new purchase order information further comprises determining the new purchase order information from the purchase order data by executing logic operations on the purchase order data using the server computer.

3. The computer implemented method of claim 1, and further comprising:
determining at a predetermined time after generating the e-mail notification whether the vendor has accessed the purchase order website and confirmed receipt of the new purchase order; and
if it is determined that the vendor has not accessed the purchase order website and confirmed receipt of the new purchase order, then further comprising automatically generating from the server computer an e-mail reminder to the vendor to access the purchase order website in order to confirm receipt of the new purchase order.

4. The computer implemented method of claim 3, and if it is determined that the vendor has accessed the purchase order website and confirmed receipt of the new purchase order, then further comprising:
determining whether the vendor has confirmed requested quantities and delivery dates specified in the purchase order; and
if it is determined that the vendor has not confirmed the requested quantities and delivery dates specified in the purchase order, then automatically generating from the server an e-mail reminder to the vendor to confirm the requested quantities and delivery dates.

5. The computer implemented method of claim 4, wherein automatically generating from the server the e-mail reminder to the vendor to confirm the requested quantities and delivery dates further comprises generating the e-mail reminder to the vendor to confirm the requested quantities and delivery dates by accessing the purchase order website.

6. The computer implemented method of claim 5, and further comprising automatically generating from the server at a predetermined time an e-mail reminder to the vendor to expedite shipping of the items specified in the new purchase order.

7. The computer implemented method of claim 6, wherein automatically generating the e-mail reminder to the vendor to expedite shipping of the items specified in the new purchase order further comprises instructing the vendor to access the purchase order website and to enter shipping information into the purchase order website.

8. The computer implemented method of claim 5, and further comprising:
determining whether the vendor has confirmed quantities or delivery dates which differ from the requested quantities and delivery dates specified in the purchase order; and
if it is determined that the vendor has confirmed quantities or delivery dates which differ from the requested quantities and delivery dates specified in the purchase order, then automatically generating an exception report.

9. The computer implemented method of claim ⁸, wherein automatically generating the exception report further comprises automatically generating an e-mail to a purchasing agent to notify the purchasing agent that the vendor has confirmed quantities or delivery dates which differ from the requested quantities and delivery dates specified in the purchase order.

10. The computer implemented method of claim 1, wherein importing purchase order data, determining new purchase order information and generating from the server computer the e-mail notification are repeated at predetermined intervals.

11. The computer implemented method of claim 1, wherein importing purchase order data from the purchase order management computer system to the server computer further comprises:
extracting the purchase order data from the purchase order management computer using a query language; and
transmitting the purchase order data to the server computer using a file transfer protocol.

12. A computer-readable medium having computer-executable instructions for performing the purchase order managing steps of:
importing purchase order data from a purchase order management computer system;
determining new purchase order information from the purchase order data; and
generating an e-mail notification to a vendor of the existence of a new purchase order for the vendor and instructing the vendor to access a purchase order website in order to confirm receipt of the new purchase order.

13. The computer-readable medium of claim 12, and further including computer-executable instructions for performing the purchase order managing steps of:
determining at a predetermined time after generating the e-mail notification whether the vendor has accessed the purchase order website and confirmed receipt of the new purchase order; and
if it is determined that the vendor has not accessed the purchase order website and confirmed receipt of the new purchase order, then further comprising automatically generating an e-mail reminder to the vendor to access the purchase order website in order to confirm receipt of the new purchase order.

14. The computer-readable medium of claim 13, and further including computer-executable instructions for performing the purchase order managing steps of:
if it is determined that the vendor has accessed the purchase order website and confirmed receipt of the new purchase order, then determining whether the vendor has confirmed requested quantities and delivery dates specified in the purchase order; and
if it is determined that the vendor has not confirmed the requested quantities and delivery dates specified in the purchase order, then automatically generating an e-mail reminder to the vendor to confirm the requested quantities and delivery dates.

15. The computer-readable medium of claim 14, wherein automatically generating the e-mail reminder to the vendor to confirm the requested quantities and delivery dates further comprises generating the e-mail reminder to the vendor to confirm the requested quantities and delivery dates by accessing the purchase order website.

16. The computer-readable medium of claim 15, and further including computer-executable instructions for performing the purchase order managing step of automatically generating at a predetermined time an e-mail reminder to the vendor to expedite shipping of the items specified in the new purchase order.

17. The computer-readable medium of claim 16, wherein automatically generating the e-mail reminder to the vendor to expedite shipping of the items specified in the new purchase order further comprises instructing the vendor to access the purchase order website and to enter shipping information into the purchase order website.

18. The computer-readable medium of claim 14, and further including computer-executable instructions for performing the purchase order managing steps of:
determining whether the vendor has confirmed quantities or delivery dates which differ from the requested quantities and delivery dates specified in the purchase order; and
if it is determined that the vendor has confirmed quantities or delivery dates which differ from the requested quantities and delivery dates specified in the purchase order, then automatically generating an exception report.
